(19) United States
(12) Patent Application Publication
(10) Pub. No.: US 2022/0253794 A1
(43) Pub. Date: Aug. 11, 2022

(54) APPARATUS AND METHOD FOR SENSING FULLNESS OF STORAGE BIN

(71) Applicant: FERROMETAL OY, Nurmijärvi (FI)

(72) Inventor: Mika BRANDT, Nurmijärvi (FI)

(21) Appl. No.: 17/622,514

(22) PCT Filed: Jun. 22, 2020
(86) PCT No.: PCT/FI2020/050441

§ 371 Date: Dec. 23, 2021

(30) Foreign Application Priority Data
Jun. 27, 2019 (FI) 20195566

(51) Int. Cl. G06Q 10/08; B65D 90/48; G06F 1/3296

(52) U.S. Cl. CPC G06Q 10/087; G06F 1/3296; B65D 90/48

(57) ABSTRACT

An apparatus, storage bin and method for determining fullness of the bin. The bin (1) is provided with an apparatus (6) comprising a sensing device (8). The sensing device sends sensing signals (10a) towards mechanical components (2) stored inside a storage space (5) of the bin and receives reflected sensing signals (10b). Bin level (11) is calculated on the basis of the sent and received signals and their time of travel. When the detected bin level is below a preset reordering point, a refill order is generated in the system for replenishing the bin.

### BACKGROUND OF THE INVENTION

The invention relates to an apparatus for sensing fullness of box-like storage bin comprising a plurality of mechanical components.

The invention further relates to a storage bin and to a method determining fullness of a storage bin.

The field of the invention is defined more specifically in the preambles of the independent claims.

Storage bins are widely used for storing mechanical components for example in assembly lines wherein industrial products are manufactured. It is essential that bin levels i.e. inventory levels of the bins do not drops to zero since otherwise the operation needs to be stopped. On the other hand, high level of inventory means increased tied-up capital causing high capital costs. Therefore automated reordering systems are developed for detecting when the amount of the components being stored in the bin diminishes and the surface thus drops. When the amount of product in the storage space has dropped below a predetermined limit, it is then possible to place a refill order for a reordering system. US-2012314059-A1 discloses an optical monitoring system utilizing image sensors such as CCD or CMOS sensor elements. The known solutions for detecting the bin fullness have shown to contain some disadvantages regarding their reliability and complexity, for example.

### BRIEF DESCRIPTION OF THE INVENTION

An object of the invention is to provide a novel and improved solution for detecting degree of filling of a storage bin comprising mechanical components.

The apparatus according to the invention is characterized by the characterizing features of the first independent apparatus claim.

The storage bin according to the invention is characterized by the characterizing features of the second independent apparatus claim.

The method according to the invention is characterized by the characterizing features of the independent method claim.

An idea of the disclosed solution is that the apparatus is intended for determining degree of filling of a component storage bin. The bin is a box like object with an open top and is able to receive mechanical components. The apparatus is arranged or is arrangeable in connection with the component storage bin. The apparatus comprises one or more sensing devices for sensing the degree of filling of the bin. The apparatus is also provided with at least one data communication device for allowing communication with external electrical devices such as to servers belonging to an electrical reordering system intended for replenishing the storage bin. The mentioned sensing device is a contactless sensor configured to send a sensing signal towards an inside space of the bin. The sensing device not only sends the sensing signal but also receives reflected sensing signals. Sensing data gathered by the apparatus is communicated to the mentioned reordering system. In other words, the solution utilizes sensing data on reflected sensing signals i.e. sensing reflected pulses or electromagnetic waves with a sensor when detecting bin level, i.e. fullness of the bin.

An advantage of the disclosed solution is that the sensing is reliable and accurate since it is based on received reflected sensing signals. The sensing is not affected by the color of the components and disclosed system can detect small objects even in poor lightning situations.

Furthermore, the disclosed solution is easy to implement and mounting of the apparatus to the bins is easy. The solution may also be retrofitted to the existing bins and ordering systems.

According to an embodiment, the apparatus comprises a transmitter for sending the sensing signal and a receiver for receiving the reflected signal.

According to an embodiment, the sensing is based on contact-free sensing or measuring. The disclosed non-contact sensing suites for sensing all kind of mechanical components.

According to an embodiment, the generated sensing data is utilized for producing automated order triggering for the electrical re-ordering system.

According to an embodiment, the bin is intended for storing a plurality of physical mechanical components. The components may be C-parts such as small fastening components.

According to an embodiment, the apparatus is configured to measure distance to a bin level defined by components stored in the bin.

According to an embodiment the apparatus is configured to compare the sensed measuring distance to a predetermined reference distance. The reference distance may be a reorder point or distance corresponding to the situation when the bin level i.e. quantity of the components inside the bin is such that new delivery of the components is received before the remaining components in the bin run out. In other words, when the sensed distance is greater than the set reference distance, a reorder is triggered to the ordering system and the bin is replenished automatically.

According to an embodiment, the apparatus comprises at least one control unit for calculating distance between the apparatus and the upper surface of the stored components. The distance is calculated in response to the detected travelling time between the sent sensing signal and the returning sensing signal reflected from the upper surface of the stored components. The apparatus sends signals and receives them when they are reflected back. The signals have thereby travelling times by means of which distance can be calculated.

According to an embodiment, the control unit of the apparatus comprises one or more processors for calculating the travelling time and corresponding distance in response to the received sensing data. In this embodiment the apparatus may send re-processed distance data to the ordering system and inventory system.

According to an embodiment, the control unit of the apparatus is configured to calculate the distance data as disclosed in the embodiment above, and is further configured to generate reorders. Then the control unit is provided with input reordering strategy, limit values, reference data or corresponding instructions for triggering the reorder. The triggered reorder may be transmitted via the wireless communication path to the ordering system or the inventory system. In this embodiment the apparatus not only produces remote sensing data and calculates distance to the bin level but also generates independently the reorders for replenishing the bin.

According to an embodiment, the apparatus locating in connection with the bin is configured to transmit the produced sensing data by means of a wireless data transmission connection to at least one server or computer provided with a processor for executing the calculations. In other words, the sensing data is processed at the external server or computer. Then there is no need to provide the apparatus with calculating capacity. The apparatus may produce the sensing data and may send the sensing data as such forwards.

According to an embodiment, the sensing device is a Time of Flight (ToF) sensor. ToF sensors are found to be reliable, versatile and accurate sensing devices.

According to an embodiment, the sensing device is a laser distance sensor.

According to an embodiment, the sensing device is an infrared sensor (IR sensor).

According to an embodiment, the sensing device is a LiDAR sensor.

According to an embodiment, the sensing device is a radar.

According to an embodiment, sensing device utilizes electromagnetic waves and the apparatus determines propagation of electromagnetic waves when calculating the bin level.

According to an embodiment, use of several sensing devices is also possible since nowadays the sensing devices are small sized and in-expensive. Further, it is possible to combine two or more different type sensing devices in connection with the disclosed apparatus.

According to an embodiment, the apparatus is a separate piece mounted in a removable manner to the storage bin. Then the apparatus may be mounted to several different bins. The apparatus may have a general design that fits for bins with different configuration. The implemented all-purpose principle allows lowering costs of the system.

According to an embodiment, the storage bin is provided with at least one mounting space configured to receive the apparatus. The bin structure may comprise a pocket or recess for receiving the apparatus. In connection with the mounting space may be shape locking means or quick coupling means for locking the apparatus.

According to an embodiment, the apparatus comprises at least one mounting element for allowing the apparatus to be mounted to the storage bin. The mounting may be based on screw mounting or on suitable fast-coupling means. The fast-coupling means may comprise spring loaded elements, for example.

According to an embodiment, the apparatus is integrated to the structure of the storage bin, whereby the apparatus is an inseparable part of the storage bin.

According to an embodiment, the storage bin may comprise two side walls with greater lengths and a front and rear wall with minor lengths. The front wall may be sloped or it may alternatively be hinged and may be turned from the vertical position to sloped position for facilitating picking of components of the bin. The apparatus is mounted on inner side surface of one side wall or rear wall. Further, the apparatus is mounted on vertical upper part of the mentioned side or rear wall.

According to an embodiment, the storage bin may have four side walls having the same lengths. The apparatus may be mounted to one of the side walls. The side walls may be perpendicular relative to the bottom of the bin.

According to an embodiment, the apparatus is mounted to a separate plate like element, which supportable against side surfaces of the bin. The plate like support element may have a planar mating surface intended to be placed against the side surface of the bin. End of the support plate may be supported against the bottom of the bin. This kind of support arrangement is easy to mount and it provides proper support for the apparatus.

According to an embodiment, the apparatus is provided with at least one electric power storage device for storing operational power for the apparatus. In order to save the stored power and to thereby ensure long service time, the control unit of the apparatus is provided with a sensing mode when the sensing device is activated and a sleeping mode when the sensing device is in non-operational state. The control unit keeps the apparatus predominantly at the sleep mode and connects the sensing mode on only at predetermined intervals. This way considerable energy savings can be achieved. Further, the apparatus may communicate to the monitoring system via a wireless data connection when the power storage device needs to be recharged or substituted with new batteries.

According to an embodiment, the sensing is implemented only at settable intervals. In other words, the operator may determine suitable time intervals between successive sensing incidents. The apparatus may activate the sensing mode once per every hour, for example. However, the sensing frequency needs to be set in accordance with the usage of the components, size of the storage bin and other inventory related issues. The setting may be easily updated.

According to an embodiment, the time interval or sensing frequency may be adjusted remotely via a wireless data communication path.

According to an embodiment, the data communication device of the apparatus is configured to communicate with the electrical reordering system through a wireless data communication connection. Then the installation and use of the apparatus is easy, and further, the monitoring is independent of location of the bin.

According to an embodiment, the wireless data communication utilizes Bluetooth.

According to an embodiment, the wireless data communication utilizes WiFi.

According to an embodiment, the wireless data communication utilizes LoRa (Long Range) wireless data communication technology.

According to an embodiment, the wireless data communication utilizes mobile radio network.

According to an embodiment, the sensing device of the apparatus is configured to send the sensing signal to one target point only. Location of the target point is selected so that is best indicates the bin level.

According to an embodiment, the apparatus may be provided with adjusting means for adjusting orientation of the sensing device so that the target point of the sensing device can be adjusted.

According to an embodiment, the sensing device of the apparatus is configured to send sensing signals to several target points. When the sensing signals are send and received from two, three or even more target points inside the storage space of the bin, then accuracy and reliability of the bin level monitoring may be increased.

According to an embodiment, the sensing device of the apparatus is configured to sweep or scan the upper level of the components inside the storage space of the bin with the sensing signal. Also in this solution reflected signals are received and analyzed.

According to an embodiment, the solution relates to a storage bin intended for storing mechanical components. The storage bin comprises a bottom and side walls surrounding the bottom. The bottom and the side walls define together a storage space with an open top. The bin is further provided with one or more apparatuses with sensing devices for sensing degree of filling of the bin. The apparatus is as disclosed in this document.

According to an embodiment, the bin is a stackable bin made of plastic material.

According to an embodiment, the bin may comprise two or more compartments, fullness of which may be monitored by means of the disclosed solution.

According to an embodiment, the bin comprises a plurality of C-parts, which typically include screws, nuts, washers, locking pins and corresponding relatively small and inexpensive mechanical components. The C-parts are with secondary importance for the end product, which may be an industrial system or machine.

According to an embodiment, the solution relates to a method of making a refill order for an electrical reordering system. The system comprises one or more storage bins each of them being provided with one or more storage spaces for receiving mechanical components. The method comprises monitoring degree of filling of the storage bin by means of at least one apparatus mounted in connection with the storage bin. The monitoring data gathered by the apparatus is communicated to the reordering system and refill orders are generated in the reordering system automatically in response to the received monitoring data. Then the storage bin is replenished in accordance with the refill order. The mentioned monitoring is executed by means of at least one sensing device of the apparatus, which sensing device senses bin level defined by the components inside the storage space of the bin. In order to sense the bin level, the sensing device sends sensing signals towards the stored components and receives sensing signals reflected from the components. The bin level sensing is based on detecting time difference between the sent and received signals and then calculating distance between the apparatus and the components. The bin level is determined in response to the calculated distance. When the detected bin level is below a pre-determined order point the refill order is generated.

According to an embodiment, the solution comprises using an independently operating apparatus which is in data communication connection with the reordering system. The independently operating apparatus may comprise a power source or its own and it communicates with the reordering system via a wireless data communication system. Thus, the apparatus is not in physical connection to a power network or to servers. The independently operating apparatus is easy to mount and connect to power and data networks.

According to an embodiment, the solution comprises executing the monitoring non-continuously at adjustable intervals. Energy is saved when active and passive periods alternate in the level monitoring, and still, reliability of the monitoring may be high. The time interval between the active and passive operations may be adjusted.

According to an embodiment, the solution comprises processing the gathered sensing data in a control unit of the apparatus and generating the refill order by means of the control unit. In this embodiment the apparatus has processing capacity and input strategy to make reordering decisions onboard the bin. Then the apparatus may simply send a reordering request to the reordering system.

According to an embodiment, the solution comprises modifying settings of the apparatus remotely via a wireless data communication connection. Then the limit values, order points, reordering quantities, time intervals between monitoring and sleeping modes, and other settable parameters may be adjusted remotely. The adjusting is then quick and easy to execute from anywhere.

According to an embodiment, the solution comprises sending the monitoring data to at least one external electrical terminal device in addition to the reordering system in order to provide data on stored mechanical components. This way it is possible to send different alarms and other messages to smart phones, for example.

According to an embodiment, the disclosed solution may be utilized not only in factories, assembly lines, storages and other static locations, but can also be utilized in mobile systems and platforms. Then the disclosed storage bins may be arranged on a movable carrier, vehicle or mobile device. The disclosed apparatus may be configured to monitor degree of fullness of the storage bin when the mobile device is moving and may communicate the produced monitoring data via a wireless data communication path to a reordering system and possible other systems. Then the vehicle or mobile device is provided with needed electrical devices for the data communication. Alternatively, the monitoring may be executed at one or more predetermined locations which are provided with the electrical communication devices. The location where the reading may be done, may be a charging or refueling place, garage, storage place or other place where the mobile device visits under its working cycle or normal use. When the vehicle or corresponding mobile device is at a range of the communication device, the monitoring is executed. The communication device may send a signal and thereby activate or “wake up” the monitoring apparatus to execute the sensing. In this implementation the monitoring is executed only at certain locations which provides in many cases enough information. The mobile carrier or device may be a car, van, truck, trailer, working machine, ship, airplane, container or trolley, for example. This embodiment is especially useful for service and maintenance operations, for example. It can be ensured that all the needed components are onboard when missions or tasks begin. The system may also produce messages and alarms for a driver or operator to take care of the needed replenishments.

The above disclosed embodiments may be combined in order to form suitable solutions having those of the above features that are needed.

### BRIEF DESCRIPTION OF THE FIGURES

Some embodiments are described in more detail in the accompanying drawings, in which

FIG. 1 is a schematic view of a storage bin provided with an apparatus for sensing fullness of the bin,

FIG. 2 is a schematic cross sectional view of a bin and two alternative mounting principles of a sensing apparatus,

FIG. 3 is a schematic diagram showing alternative sensors of the sensing device, and

FIG. 4 is a diagram showing components relating to the disclosed system and transfer of different data between them.

For the sake of clarity, the figures show some embodiments of the disclosed solution in a simplified manner. In the figures, like reference numerals identify like elements.

### Detailed Description of Some Embodiments

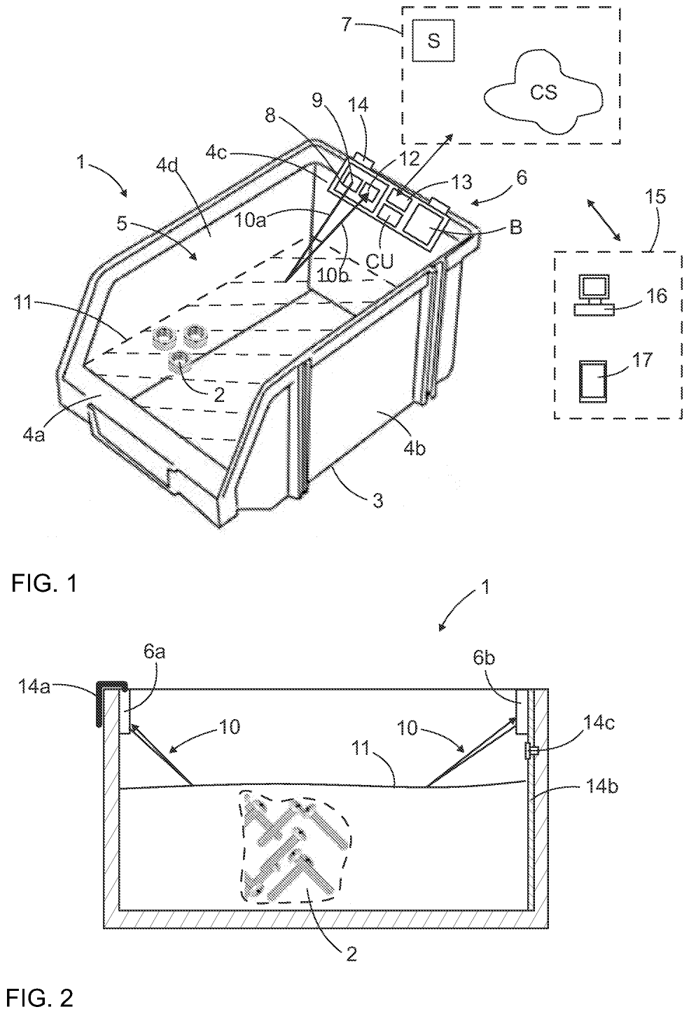

FIG. 1 shows a storage bin 1 intended for receiving mechanical components 2, such as nuts, washers and screws. The bin 1 is box-like piece comprising a bottom 3, side walls 4a-4d and an open top. Inside the bin 1 is a storage space 5. The bin 1 is provided with an apparatus 6 for sensing an upper layer of the components 2 inside the storage space 5 in order to detect if a refill order needs to be generated for a reordering system 7. The apparatus 6 comprises a sensing device 8 provided with a transmitter 9 for sending a sensing signal 10a towards the upper layer of the components i.e. a bin layer 11, and a receiver 12 for receiving a reflected sensing signal 10b. The apparatus 6 further comprises a control unit CU for controlling operation of the apparatus 6 and a data communication device 13 for allowing wireless communication. There is also an electric power storage B, such as battery for providing needed electrical energy for the apparatus 6. The apparatus 6 may be mounted in a removable manner to one side wall, in this case it is mounted to an upper part of the rear wall 4c. The apparatus 6 may comprise mounting means 14, such as fast coupling means, supporting hooks, brackets, screws or clamps.

The apparatus 6 may send sensing results to the reordering system 7 as such, or the sensing data may be reprocessed in the control unit CU and a refill order will be send to the system. The reordering system 7 may comprises one or more servers S. Alternatively, or in addition to, the reordering system may comprise a cloud service CS. The reordering system 7 is provided with data on a suitable reordering point, which may correspond to a distance sensed between the bin level 11 and the apparatus 6. Further, the reordering system 7 may communicate with one or more other electrical terminal devices 15, such as computers 16 and smart phones 17 and may thereby provide desired information, monitoring data, alarms and messages to selected users and systems.

FIG. 2 discloses a bin 1 and two alternative mounting arrangements for an apparatus 6. First mounting means 14a of a first apparatus 6a is a hook and second mounting means 14b of a second apparatus 6b is a plate arranged against a side surface of the bin 1. The plate may also be provided with mounting screws 14c or corresponding elements. The apparatuses 6a, 6b send and receive sensing signals 10 in manner disclosed in this document. It is to be noted, that other mounting arrangements may also be implemented.

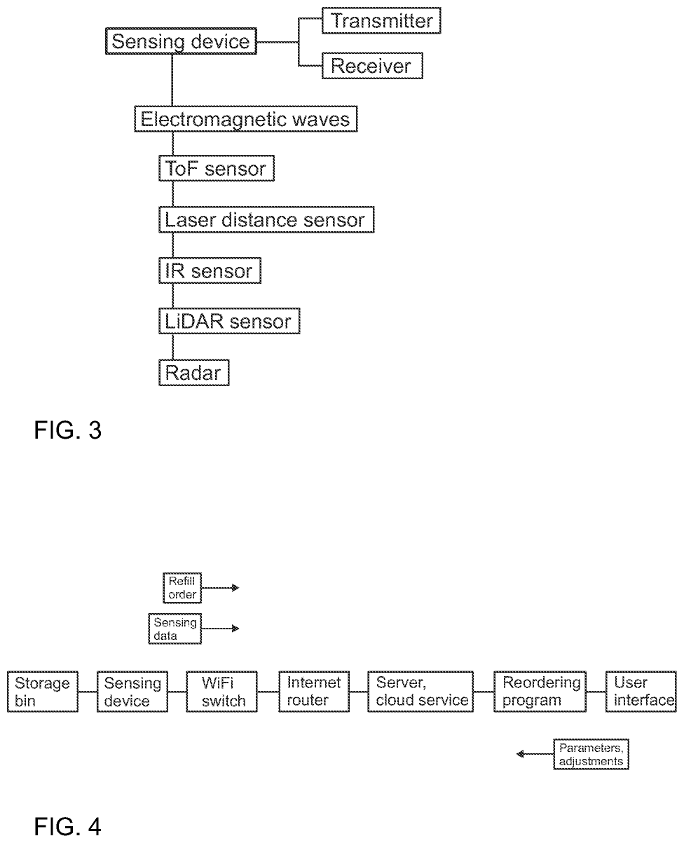

FIG. 3 discloses features of a sensing device and possible alternative sensing technology suitable for the purpose. These issues have already been discussed above in this document.

FIG. 4 discloses basic components of the disclosed arrangement. Bin level of a bin can be detected by means of a sensing device and the sensing data may be send for further processing, or a reprocessed refill order may be generated. The apparatus comprising the sensing device may communicate in a wireless manner with servers and a cloud service via a WiFi connection and the Internet. A reordering program receives the sensing data or the reprocessed refill order and executes needed replenishing actions based on them. The system may also comprise a user interface through which an operator may communicate with the system. The operator is provided with needed data on inventory, such as reports and notifications, for example. The operator may also adjust parameters of the system, such a reordering points and monitoring frequency.

The drawings and the related description are only intended to illustrate the idea of the invention. In its details, the invention may vary within the scope of the claims.

1. An apparatus for determining degree of filling of a component storage bin, wherein the bin is a box like object with an open top and which bin is intended for receiving mechanical components;
and wherein the apparatus is arranged in connection with the component storage bin and comprises:
at least one sensing device for sensing the degree of filling of the bin; and
at least one data communication device for allowing communication with at least one electrical device external to the bin and belonging to an electrical reordering system intended for replenishing the storage bin;
and wherein the sensing device is a contactless sensor configured to send a sensing signal towards an inside space of the bin and is configured to receive reflected sensing signal; and
the sensing data is configured to be communicated to the mentioned reordering system;
characterized in that
the apparatus comprises at least one control unit for calculating distance between the apparatus and the upper surface of the stored components in response to travelling time between the sent sensing signal and the returning sensing signal reflected from the upper surface of the stored components and received by the apparatus.

2. The apparatus as claimed in claim 1, characterized in that
the apparatus is configured to measure distance to a bin level defined by components stored inside the bin.

3. The apparatus as claimed in claim 1, characterized in that
the sensing device is a Time of Flight (ToF) sensor.

4. The apparatus as claimed in claim 1, characterized in that
the apparatus is a separate piece mounted in a removable manner to the storage bin.

5. The apparatus as claimed in claim 1, characterized in that
the apparatus is provided with at least one electric power storage device for storing operational power for the apparatus;
the control unit of the apparatus is provided with a sensing mode when the sensing device is activated and a sleeping mode when the sensing device is in non-operational state; and
the control unit is configured to keep the apparatus predominantly at the sleep mode and is configured to connect the sensing mode on only at predetermined intervals in order to save electric energy of the electric power storage device.

6. The apparatus as claimed in claim 1, characterized in that
the data communication device of the apparatus is configured to communicate with the electrical reordering system through a wireless data communication connection.

7. A storage bin for storing mechanical components,
and wherein the storage bin comprises:
a bottom and surrounding side walls which define together a storage space with an open top; and
at least one apparatus provided with a sensing device for sensing degree of filling of the bin;
characterized in that
the mentioned apparatus is in accordance with the claim 1.

8. A method of making a refill order for an electrical reordering system connected to at least one storage bin provided with a storage space for receiving mechanical components;
wherein the method comprises:
monitoring degree of filling of the storage bin by means of at least one apparatus mounted in connection with the storage bin;
communicating the monitoring data gathered by the apparatus to the reordering system;
generating in the reordering system automatically refill orders in response to the received monitoring data;
replenishing the storage bin in accordance with the refill order; monitoring by means of at least one sensing device of the apparatus bin level defined by the components inside the storage space of the bin;
sending sensing signals towards the stored components and receiving sensing signals reflected from the components; and generating the refill order when the detected bin level is below a predetermined order point.
characterized by
detecting time difference between the sent and received signals and calculating distance between the apparatus and the components; and
determining the bin level in response to the calculated distance.

9. The method as claimed in claim 8, characterized by
using an independently operating apparatus which is in data communication connection with the reordering system.

10. The method as claimed in claim 8, characterized by
executing the monitoring non-continuously at adjustable intervals.

11. The method as claimed in claim 8, characterized by
processing the gathered sensing data in a control unit of the apparatus and generating the refill order by means of the control unit.

12. The method as claimed in claim 8, characterized by
modifying settings of the apparatus remotely via a wireless data communication connection.

13. The method as claimed in claim 8, characterized by
sending the monitoring data to at least one external electrical terminal device in addition to the reordering system in order to provide data on stored mechanical components.
